(19) United States
(12) Patent Application Publication
(10) Pub. No.: US 2025/0276888 A1
(43) Pub. Date: Sep. 4, 2025

(54) GAS HOSE PULL AWAY ALARM SYSTEM

(71) Applicant: Ardehsir Farhangdoost, Livermore, CA (US)

(72) Inventor: Ardehsir Farhangdoost, Livermore, CA (US)

(21) Appl. No.: 18/593,268

(22) Filed: Mar. 1, 2024

(51) Int. Cl. B67D 7/32; B67D 7/04; B67D 7/38

(52) U.S. Cl. CPC B67D 7/3218; B67D 7/0401; B67D 7/38

(57) ABSTRACT

An apparatus configured to detect a gas hose pull away event at a gas station includes a gas hose sensor configured to detect when a gas hose is pulled away from a gas pump, a visual alarm configured to be activated in response to detection that the gas hose has been pulled away from the gas pump, an audible alarm configured to be activated in response to detection that the gas hose has been pulled away from the gas pump, a mounting bracket configured to attach the apparatus to a fixed location on or proximate to the gas pump, and an electrical connection configured to provide electrical power. In one example, the gas hose sensor includes a cord, a wire, or a string that is attached to the gas hose. In another example, the sensor is attached to the gas hose utilizing a clamp, a tie, or a magnet.

### TECHNICAL FIELD

The described embodiments relate generally to an apparatus and method for generating a gas station alert and more particularly to an apparatus and method for generating an alert when a gas hose pull away event occurs.

### BACKGROUND INFORMATION

Although the majority of drivers operate gas station pumps correctly and safely during vehicle refueling, instances occur where drivers inadvertently forget to remove the gas nozzle before driving away from the station. This oversight poses various risks and costs for both the driver and the gas station. Below are some of the potential consequences associated with vehicles departing from gas stations while the gas nozzle remains inserted into the vehicle.

One of the most immediate risks is the potential for a fire or explosion. If the nozzle is detached forcefully or if the fuel line ruptures, it can lead to the release of gasoline, which is highly flammable. A spark from static electricity or friction could ignite the fuel vapors, resulting in a fire.

The force of the vehicle moving away with the nozzle attached can cause damage to both the gas pump and the vehicle itself. This may include broken fuel lines, damaged fuel pumps, or scratches and dents on the vehicle.

There's a risk of personal injury to the driver, bystanders, or gas station attendants if they are in the vicinity when the incident occurs. Flying debris or a sudden jolt from the nozzle detaching can cause injuries.

When a vehicle drives away with the nozzle still inserted, it can lead to fuel spillage, which is harmful to the environment. Spilled gasoline can contaminate soil and water sources, posing a threat to ecosystems and wildlife.

In addition to the immediate spillage, the release of gasoline vapors into the air contributes to air pollution. These vapors contain volatile organic compounds (VOCs) that contribute to smog formation and have adverse effects on air quality.

Both the gas station and the vehicle owner may incur repair expenses as a result of the incident. The gas station may need to repair or replace damaged fuel pumps and nozzles, while the vehicle owner may need to repair any damage caused to their vehicle.

If the incident causes damage to property or injury to individuals, the driver may be held legally liable for the damages. This could result in costly legal fees, settlements, or insurance claims.

For gas station owners, an incident involving a vehicle driving away with the nozzle still attached can lead to downtime for repairs and cleanup. This can disrupt business operations and result in lost revenue.

To mitigate these risks and costs, gas stations often employ safety mechanisms such as breakaway nozzles, which disconnect from the pump when excessive force is applied. Additionally, signage and reminders are typically placed near the pumps to alert drivers to remove the nozzle before driving away. However, accidents can still occur due to human error or negligence. Therefore, it's crucial for drivers to remain vigilant and follow safety protocols when refueling their vehicles.

While the breakaway nozzles and signage are helpful, a solution providing additional safety and liability protection is needed.

### SUMMARY

In a first novel aspect, an apparatus configured to detect a gas hose pull away event at a gas station includes a gas hose sensor configured to detect when a gas hose is pulled away from a gas pump, a visual alarm configured to be activated in response to detection that the gas hose has been pulled away from the gas pump, an audible alarm configured to be activated in response to detection that the gas hose has been pulled away from the gas pump, a mounting bracket configured to attached the apparatus to a fixed location on or proximate to the gas pump, and an electrical connection configured to provide electrical power.

In a second novel aspect, the gas hose sensor includes a cord, a wire, or a string that is attached to the gas hose.

In a third novel aspect, the sensor is attached to the gas hose utilizing a clamp, a tie, or a magnet.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a diagram of a gas station pump.

FIG. 2 is a diagram of a vehicle driving away with the gas nozzle attached to the vehicle.

FIG. 3 is a diagram of a gas hose and nozzle laying on the floor after vehicle drive away breakage.

FIG. 4 is a diagram of a vehicle driving away with a gas hose and nozzle still attached to the vehicle.

FIG. 5. is a diagram of a gas hose pull away alarm system.

FIG. 6. is a diagram of an analog circuit controlled gas hose pull away alarm system.

FIG. 7 is a diagram of a digital and wireless circuit controlled gas hose pull away alarm system.

FIG. 8 is a diagram of a gas station pump with a gas hose pull away alarm system.

FIG. 9 is a diagram of a gas station pump with a gas hose pull away alarm system.

FIG. 10 is a diagram of a gas station pump with gas hose pull away alarm system engaged after a gas hose pull away event.

FIG. 11 is a diagram of a gas station pump with gas hose pull away alarm system engaged after a gas hose pull away event.

FIG. 12 is a flowchart diagram illustrating the steps included in gas hose pull away alarm unit installation.

FIG. 13 is a flowchart diagram illustrating the operation of the gas hose pull away alarm system.

FIG. 14 is a flowchart diagram illustrating how the gas hose pull away alarm system is reset.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

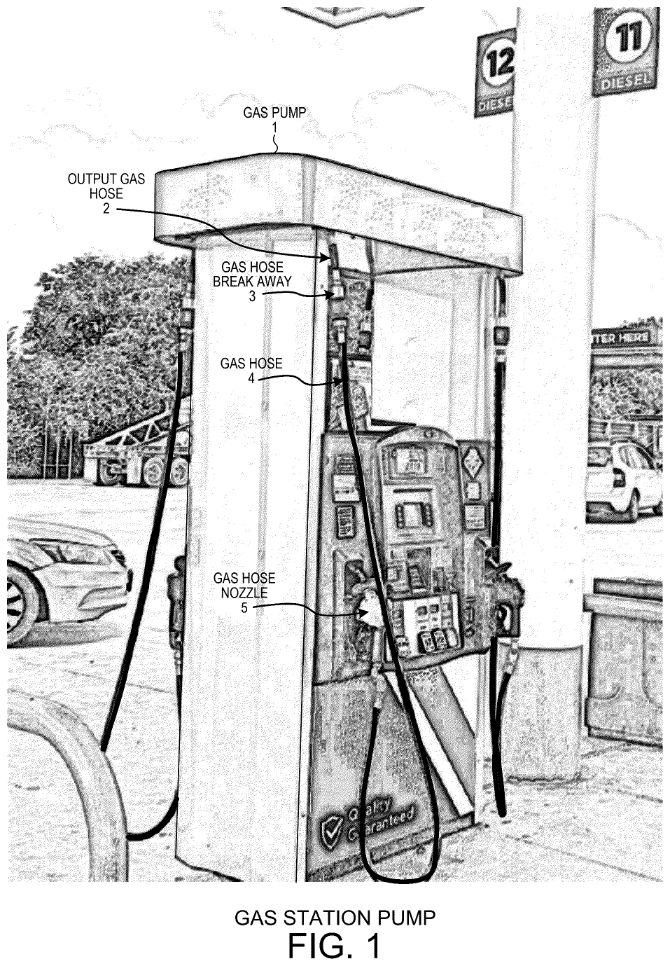

FIG. 1 is a diagram of a gas station gas pump. A gas station gas pump 1, also known as a fuel dispenser, is a complex piece of machinery designed to safely and efficiently dispense fuel to vehicles. A detailed description of how a typical gas pump works, along with associated costs of installation and maintenance is provided herein.

The fuel dispenser is connected to an underground storage tank where gasoline or diesel fuel is stored. These tanks are typically made of corrosion-resistant materials and equipped with safety features to prevent leaks or spills. Inside the dispenser, there are one or more pumps that draw fuel from the storage tank and deliver it to the vehicle's fuel tank. These pumps are usually powered by electricity and equipped with filters to remove any impurities from the fuel. As fuel is pumped, it passes through a metering system that accurately measures the volume of fuel dispensed. This ensures that customers are charged the correct amount for the fuel they receive. The fuel is delivered to the vehicle through a nozzle 5 attached to a flexible hose 4. The nozzle typically includes a trigger mechanism that allows the customer to control the flow of fuel. Some nozzles also feature vapor recovery systems to capture gasoline vapors and reduce air pollution. Modern gas pumps are equipped with payment terminals that accept various forms of payment, including credit/debit cards, mobile payments, and cash. Customers can select the type and amount of fuel they want and complete the transaction securely.

Gas pumps are equipped with various safety features to prevent accidents and spills. These may include automatic shutoff mechanisms that stop the flow of fuel if the nozzle is removed or if fuel is detected outside the vehicle's fuel tank. Gas pumps may also include gas hose break away 3 that functions to disconnect the gas hose 4 form the output gas hose 2 and stop the flow of gas when the gas hose 4 is pulled away from the gas pump.

The cost of installing a gas pump can vary depending on factors such as the type of fuel, the number of dispensers, local regulations, and site preparation requirements. On average, installation costs can range from $20,000 to $100,000 per pump. In addition to the pump itself, gas station owners must also consider the cost of ancillary equipment such as underground storage tanks, piping, dispensers, payment terminals, and safety systems. These costs can add up significantly, depending on the size and complexity of the station. Gas pumps require regular maintenance to ensure they operate safely and efficiently. This may include inspections, calibration of meters, replacement of worn parts, and testing of safety systems. Maintenance costs can vary depending on the age and condition of the equipment but typically range from a few thousand to tens of thousands of dollars per year per pump. Gas station owners must comply with various regulations and safety standards set by local authorities and environmental agencies. This may involve additional costs for inspections, permits, and upgrades to meet changing requirements.

Overall, while the initial investment in a gas pump and associated equipment can be substantial, ongoing maintenance and compliance costs are necessary to ensure the safe and reliable operation of the fueling facility.

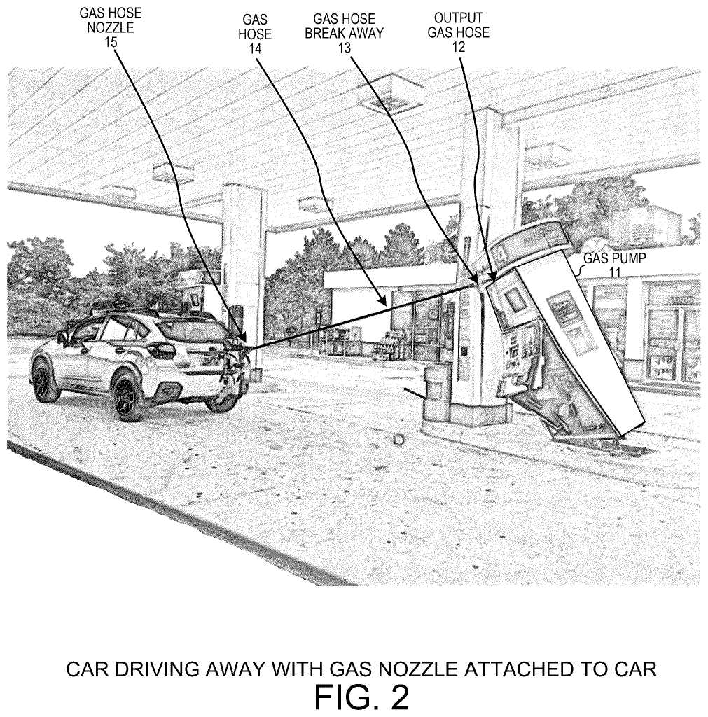

FIG. 2 is a diagram of a vehicle driving away with the gas nozzle 15 attached to the vehicle. When a vehicle drives away from a gas station pump with the gas nozzle still attached, several events unfold in a potentially dangerous sequence.

First, as the driver pulls away, the gas nozzle 15 remains inserted into the vehicle's fuel tank. This could occur due to distraction, forgetfulness, or simply not noticing that the nozzle hasn't been removed.

Second, as the vehicle moves forward, tension is created on the hose 14 connecting the nozzle to the gas pump 11. This tension increases as the distance between the pump and the vehicle grows, causing stress on the hose and the pump's connection system.

Third, many modern gas pumps are equipped with safety mechanisms designed to prevent accidents in such situations. These mechanisms may include breakaway systems 13 that disconnect the hose from the pump or shut off valves that stop the flow of fuel. When these mechanisms are used, the gas nozzle and connected gas hose are separated from the gas pump.

Fourth, if the safety mechanisms fail to activate or if the force exerted by the vehicle is too great, the hose may detach from the pump forcefully. This can result in a sudden release of fuel from the pump and the hose, creating a hazardous situation.

With the hose detached, there's a risk of fuel spilling onto the ground or onto the vehicle itself. Spilled fuel can create slippery surfaces, increase the risk of fire or explosion, and cause environmental damage if it reaches soil or water sources.

The forceful detachment of the hose can also cause damage to the gas pump and the dispenser system. This may include broken hoses, damaged connectors, or even structural damage to the pump itself.

If fuel spills onto the ground and comes into contact with a spark or ignition source, it can ignite, leading to a fire or explosion. Gasoline vapors are highly flammable, and even a small spark can have catastrophic consequences.

In addition to the risk of fire, there's also a risk of personal injury or property damage if the detached hose strikes individuals, vehicles, or other objects in the vicinity.

Overall, driving away from a gas station pump with the nozzle still attached can lead to a chain of events with serious safety implications for both the driver and others nearby. It's essential for drivers to remain vigilant and always ensure that the gas nozzle is properly detached before leaving the pump area.

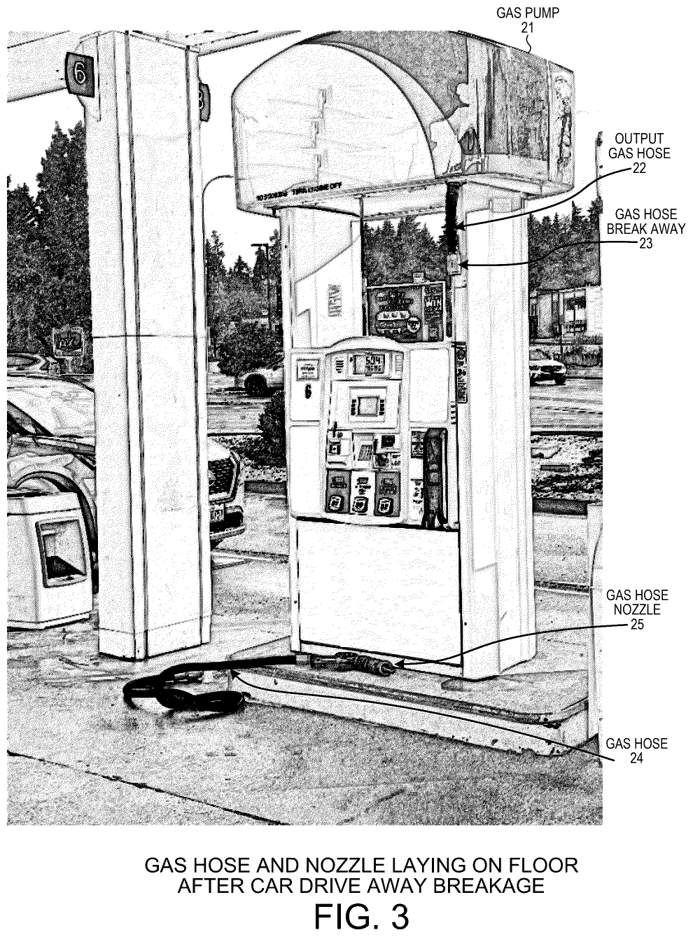

FIG. 3 is a diagram of a gas hose 24 and nozzle 25 laying on the floor after vehicle drive away breakage. The diagram depicts a gas pump scenario where an unfortunate incident has occurred. At the center of the diagram stands a typical gas pump 21, characterized by its rectangular frame and prominent display screen. The diagram illustrates the aftermath of a vehicle pulling away with the gas nozzle still attached.

The gas pump unit is illustrated with its various components, including the display screen, payment keypad, and slots for card insertion. A digital display on the pump unit may indicate the amount of fuel dispensed, but it now likely flashes an error message or warning sign. Extending from the gas pump unit is a flexible gas hose 22, typically made of durable material to withstand frequent use. On the floor, the detached gas hose 24 is depicted as trailing along the ground, indicating its detachment from the gas pump nozzle. The gas nozzle 25, originally connected to the gas pump, is also lying on the ground, separated from the pump.

The diagram serves as a visual representation of a gas pump incident caused by a vehicle pulling away with the gas nozzle still connected, highlighting the potential dangers and emphasizing the importance of safe refueling practices.

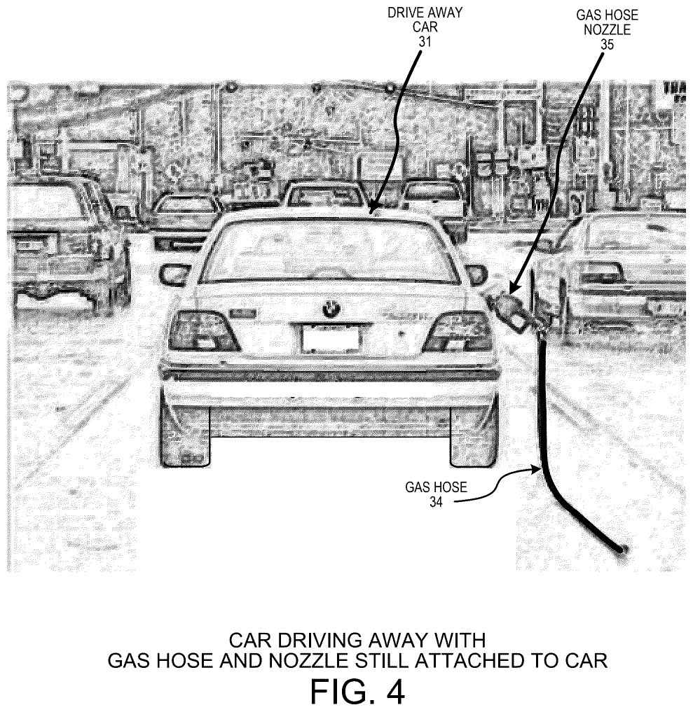

FIG. 4 is a diagram of a vehicle driving away with a gas hose and nozzle still attached to the vehicle. The vehicle 31 is driving with traffic along a street. A gas hose 34 and gas nozzle 35 are still attached to the vehicle. The driver of the vehicle likely is unaware that they have ripped the gas hose away from a gas pump and that they are now dragging the gas hose behind their vehicle as they drive down the street.

This scenario is very dangerous. The gas hose may be leaking gas onto the street which could lead to potential fire. The gas hose could also get stuck under the tire of another vehicle and cause a traffic accident. Moreover, the gas hose could come loose and strike another vehicle traveling on the street.

It is very advantageous to notify a driver that they have inadvertently pulled the gas hose away from the gas pump before they drive away from the gas station.

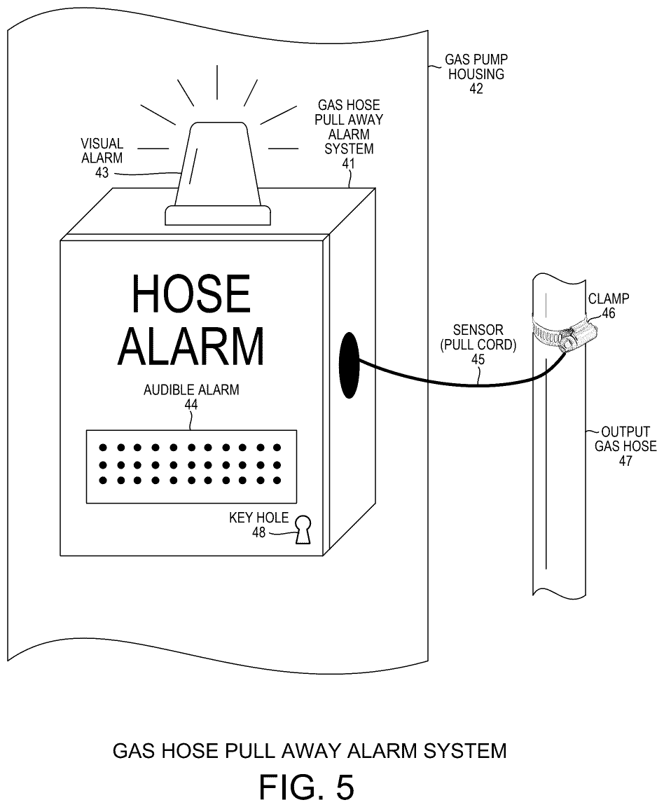

FIG. 5. is a diagram of a gas hose pull away alarm system. The gas hose pull away alarm system 41 includes a visual alarm 43, an audible alarm 44, a sensor 45 and a key hole 48. In one example, the gas hose pull away alarm system is attached to gas pump housing 42. The sensor 45 is configured to sense when the output gas hose 47 is pulled away from the gas pump.

The gas hose pull away alarm system may only include a visual alarm. Conversely, the gas hose pull away alarm system may only include an audible alarm.

In a first embodiment, the sensor is a cord, a wire, or a string. The sensor is attached to the output gas hose via a clamp, a ring, a tie, an adhesive, a weld, or a magnet. The cord, wire, or string may be retractable so to reduce the amount of slack when the gas hose is attached to the gas pump. The retractable function may be implemented using a spring retraction system.

In a second embodiment the sensor may be a wireless device, such as an accelerometer, a radio frequency identification (RFID) tag, a GPS tag, a Bluetooth tag, or a wifi tag.

It is noted herein, that after review of the present application, one skilled in the art will readily understand various methods of sensing a gas hose pull away event.

The visual alarm includes a light source. The visual alarm may include a light source configured to turn on and off at a frequency. The visual alarm may be configured to direct light at an angle that varies with time. The light source may be a light emitting diode (LED), an incandescent light, or any other device capable of emitting light.

The audible alarm may include a speaker or a bell. The audible alarm may also include a memory circuit configured to store audio information. An amplifier may also be included in the audible alarm.

In operation, the gas hose pull away alarm system 41 detects when the output gas hose 47 is pulled away from the gas pump via the sensor 45. In response to detecting the gas hose pull away event, the gas hose pull away alarm system causes the visual alarm 43 or the audible alarm 44 to turn on. The alarm serves to alert the gas station attendant that a gas hose pull away event has occurred. In response, the gas station attendant goes to the gas pump to notify the vehicle driver that they have not removed the gas nozzle from their vehicle, safely remove the gas nozzle from the vehicle, and collect the driver's information, including but not limited to insurance and contact information. This information can be used by the gas station to collect insurance funds to repair the gas pump, which as described above, is a significant cost.

After notifying the driver, safely removing the gas nozzle, and collecting the necessary information, the gas station attendant will unlock the gas hose pull away alarm system enclosure and turn off the alarm. In one example, the enclosure is unlocked by a key, a combination lock code, or a wireless signal triggering an internal lock.

Once the alarm is turned off, the gas station attendant can reset the alarm by reattaching or re-enabling the sensor. In one example, the alarm is reset by re-inserting a pull pin into a pin activated switch located within the gas hose pull away alarm system. In another example, the alarm is reset by re-connecting a magnet to a magnet activated switch located within the gas hose pull away alarm system. The switch is configured to turn on the visual alarm and audible alarm.

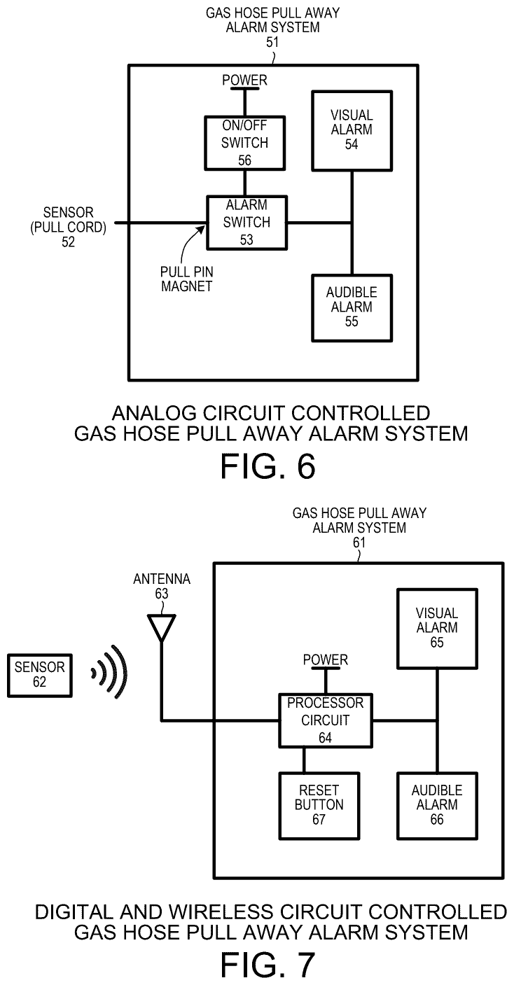

FIG. 6. Is a diagram of an analog circuit-controlled gas hose pull away alarm system. The analog circuit-controlled gas hose pull away alarm system includes a sensor 52, an alarm switch 53, an on/off switch 56, a visual alarm 54 and an audible alarm 55. The on/off switch serves to enable or disable the alarm system. When the alarm system is enabled, the alarm switch 53 causes the visual alarm and the audible alarm to be powered on when the sensor indicates that the gas hose has been pulled away from the gas pump.

The gas hose pull away alarm system can be powered by either battery direct current (DC) electrical power or an alternating current (AC) power source. In the case of battery power, a battery may be included in the alarm enclosure.

FIG. 7 is a diagram of a digital and wireless circuit-controlled gas hose pull away alarm system. The digital and wireless circuit-controlled gas hose pull away alarm system includes an antenna 63, a processor circuit 64, a reset button 67, a visual alarm 65, and an audible alarm 66. The antenna 63 is configured to receive a wireless signal from wireless sensor 62. The wireless signal is then demodulated and decoded into a digital data by the processor circuit. The digital data is then processed to determine if a gas hose pull away event has occurred. When a gas hose pull away event is detected, the processor circuit turns on the visual alarm and the audible alarm. After an alarm event, the alarm can be disabled by opening the gas hose pull away alarm system enclosure and pressing the reset button. The processor circuit turns off the visual alarm and the audible alarm when the reset button is pressed.

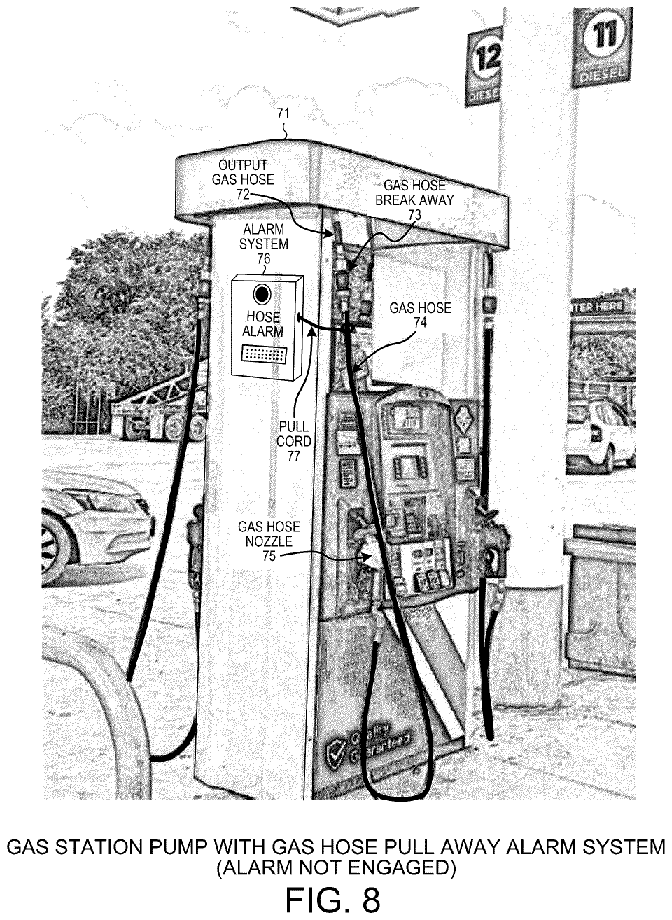

FIG. 8 is a diagram of a gas station pump with a gas hose pull away alarm system. In the illustrated embodiment, the gas hose pull away alarm system has a cord, wire, or string that extends out from a side surface of the alarm enclosure and attaches to the gas hose via a clamp. Once the gas hose 74 is pulled away from the gas pump, the cord, wire, or string pulls the pin or magnet away from an internal switch that enables the visual and audible alarms.

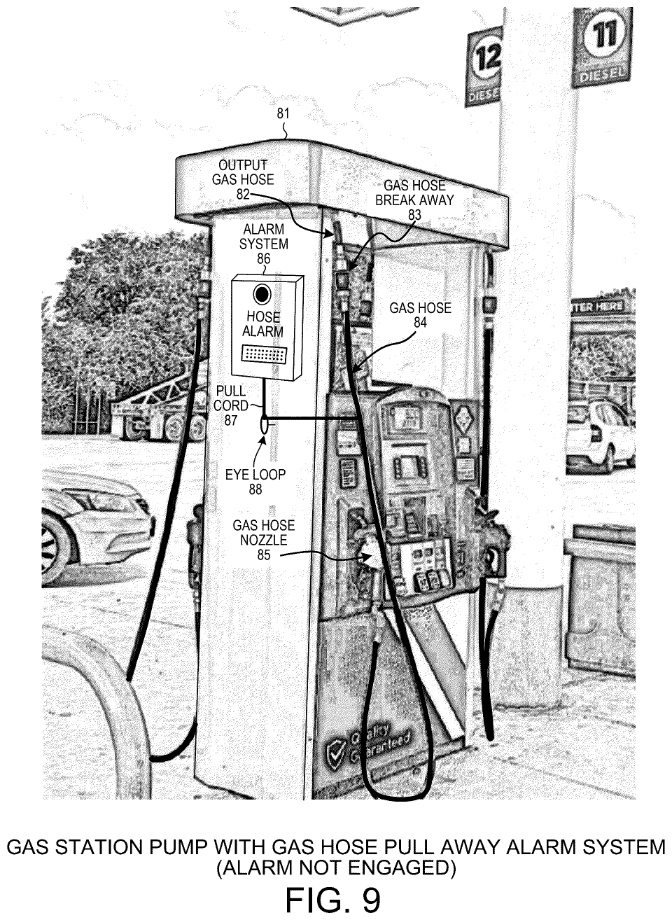

FIG. 9 is a diagram of a gas station pump with a gas hose pull away alarm system. In the illustrated embodiment, the gas hose pull away alarm system has a cord, wire, or string that extends out from the bottom surface of the alarm enclosure, passes through a metal or plastic loop 88 and attaches to the gas hose via a clamp. Once the gas hose 84 is pulled away from the gas pump, the cord, wire, or string pulls the pin or magnet away from an internal switch that enables the visual and audible alarms. This configuration controls the angle at which the cord, wire, or string pulls away from the alarm.

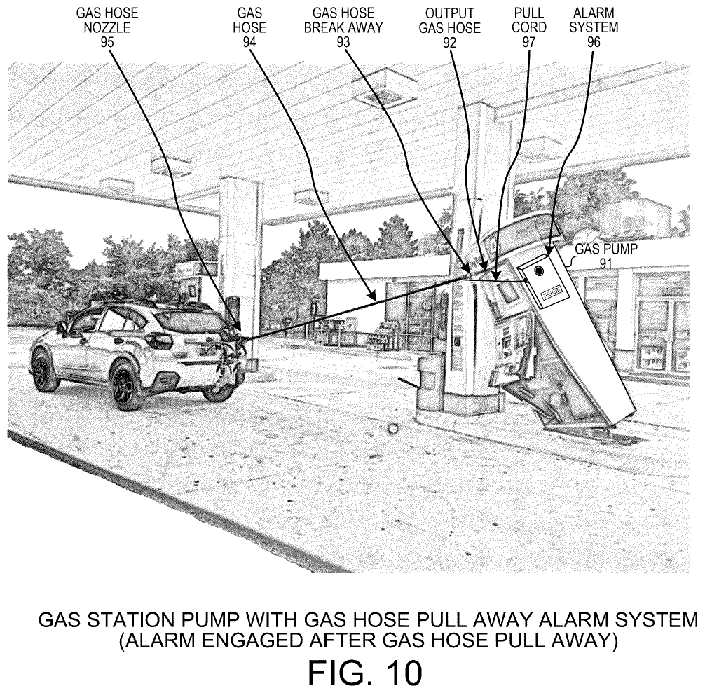

FIG. 10 is a diagram of a gas station pump with gas hose pull away alarm system engaged during a gas hose pull away event. This figure illustrates how the cord, wire, or string sensor is pulled when the gas hose is pulled away from the gas pump. Since the sensor is attached to the gas pump, the sensor also gets pulled away from the alarm system. When the cord, wire, or string is pulled, the visual and audible alarms are enabled to get the attention of the gas station attendant.

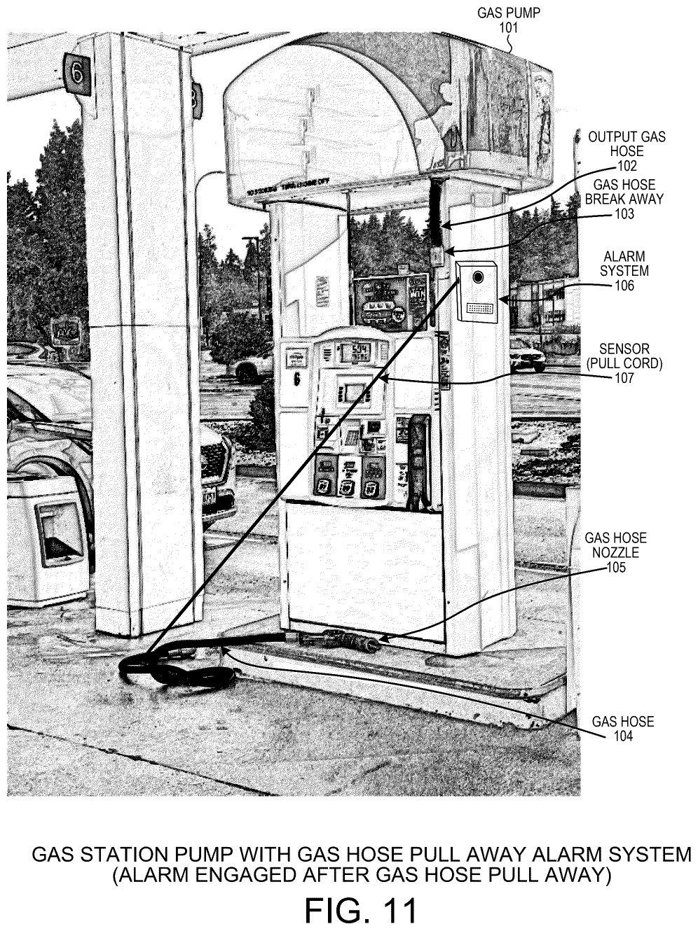

FIG. 11 is a diagram of a gas station pump with gas hose pull away alarm system engaged after a gas hose pull away event. This figure illustrates how the cord, wire, or string sensor is pulled when the gas hose is pulled away from the gas pump. Since the sensor is attached to the gas hose, the sensor also gets pulled away from the alarm system. When the cord, wire, or string is pulled, the visual and audible alarms are enabled to get the attention of the gas station attendant.

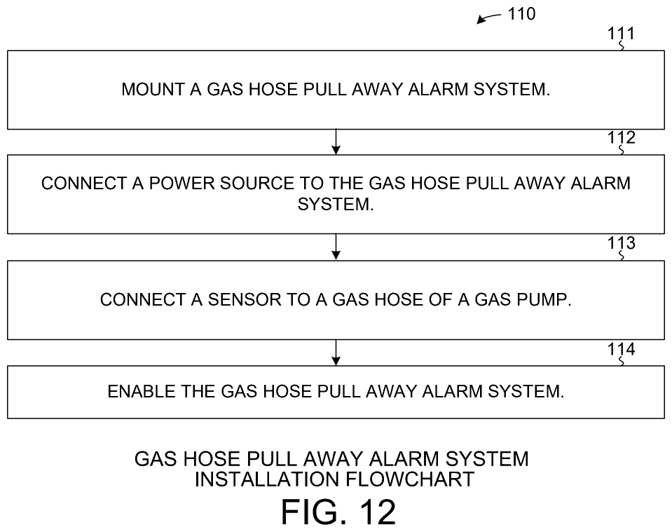

FIG. 12 is a flowchart diagram illustrating the steps included in a gas hose pull away alarm unit installation. In step 111, a gas hose pull away alarm system is mounted. In step 112, a power source is connected to the gas hose pull away alarm system. In step 113, a sensor is connected to a gas hose that is connected to a gas pump. In step 114, the gas hose pull away alarm system is enabled.

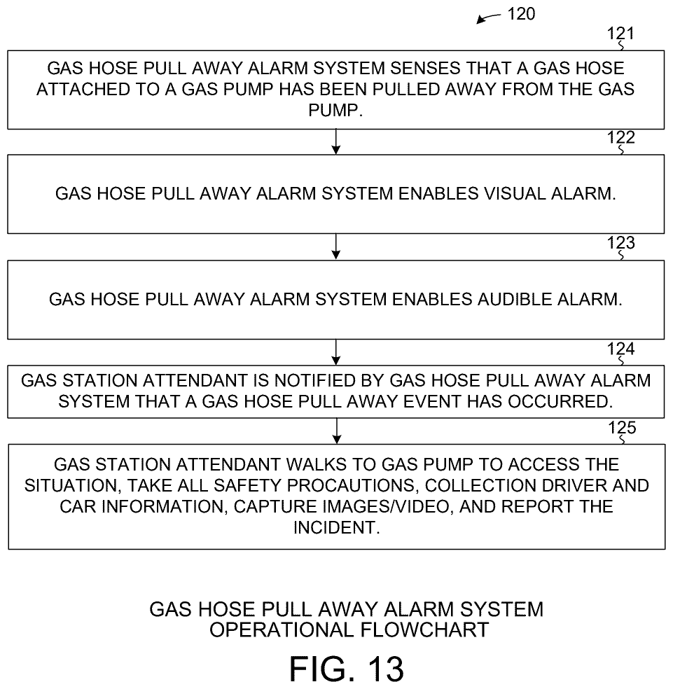

FIG. 13 is a flowchart diagram illustrating the operation of the gas hose pull away alarm system. In step 121, the gas hose pull away alarm system senses that a gas hose attached to a gas pump was been pulled away from the gas pump. In step 122, a visual alarm is turned on. In step 123, an audible alarm is turned on. In step 124, a gas station attendant is notified by the gas hose pull away alarm system that a gas hose pull away event has occurred. In step 125, the gas station attendant goes to the gas pump to assess the situation, take all safety precautions, collect driver and insurance information, capture images/videos, and report the incident.

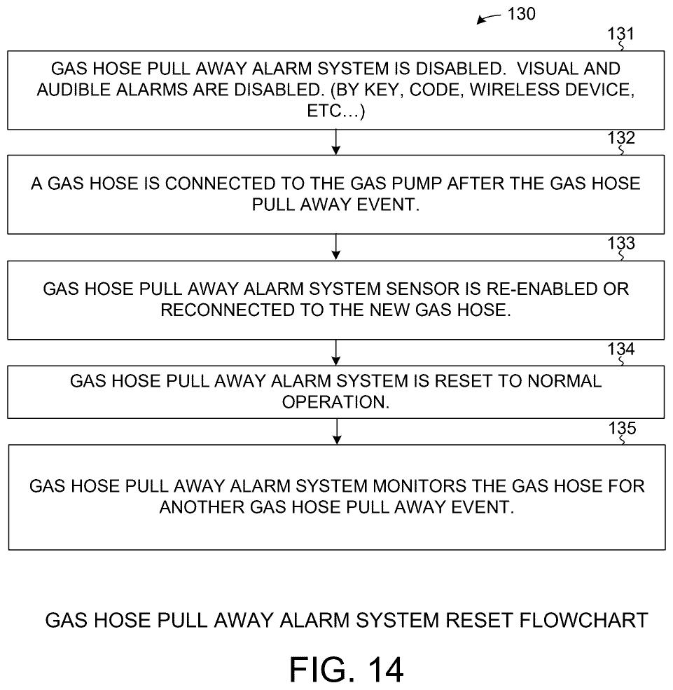

FIG. 14 is a flowchart diagram illustrating how the gas hose pull away alarm system is reset. In step 131, the gas hose pull away alarm system is disabled. The visual and audible alarms are turned off. In step 132, a gas hose is connected to the gas pump after a gas hose pull away event has occurred. In step 133, the gas hose pull away alarm system sensor is re-enabled or reconnected to the new gas hose. In step 134, the gas hose pull away alarm system is reset to normal operation. In step 135, the gas hose pull away alarm system monitors the new gas hose for another gas hose pull away event.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An apparatus configured to detect a gas hose pull away event at a gas station, comprising:
a gas hose sensor configured to detect when a gas hose is pulled away from a gas pump;
a visual alarm configured to be activated in response to detection that the gas hose has been pulled away from the gas pump;
an audible alarm configured to be activated in response to detection that the gas hose has been pulled away from the gas pump;
a mounting bracket configured to attach the apparatus to a fixed location on or proximate to the gas pump; and
an electrical connection configured to provide electrical power to the apparatus.

2. The apparatus of claim 1, wherein the gas hose sensor includes a cord, a wire, or a string that is attached to the gas hose.

3. The apparatus of claim 2, wherein the cord, the wire, or the string is attached to the gas hose utilizing a clamp, a tie, or a magnet.

4. The apparatus of claim 3, wherein the clamp, the tie, or the magnet includes a metal material or a plastic material.

5. The apparatus of claim 1, wherein the gas hose sensor is a wireless sensor device.

6. The apparatus of claim 5, wherein the wireless sensor device includes a Radio Frequency Identification (RFID) tag.

7. The apparatus of claim 5, wherein the wireless sensor device includes an accelerometer.

8. The apparatus of claim 5, wherein the wireless sensor device includes a proximity device.

9. The apparatus of claim 1, wherein the visual alarm includes a light source.

10. The apparatus of claim 9, wherein the visual alarm is configured to enable and disable the light source at a first frequency.

11. The apparatus of claim 9, wherein the visual alarm is configured to direct light at an angle that varies with time.

12. The apparatus of claim 1, wherein the audible alarm includes a speaker.

13. The apparatus of claim 1, wherein the audible alarm includes a bell.

14. The apparatus of claim 1, wherein the audible alarm includes a memory circuit configured to store audio information.

15. The apparatus of claim 1, wherein the audible alarm includes an amplifier.

16. The apparatus of claim 1, wherein the electrical connection is configured to connect to an alternating current (AC) power source.

17. The apparatus of claim 1, wherein the electrical connection is configured to connect to a battery power source.

18. The apparatus of claim 1, further comprising a switch configured to enable the visual alarm or the audible alarm when a gas hose pull away event is detected.

19. The apparatus of claim 1, further comprising a processing circuit configured to enable the visual alarm or the audible alarm when a gas hose pull away event is detected.

20. The apparatus of claim 2, further comprising a spring configured to retract the cord, wire, or string into the apparatus.
